(19) United States
(12) Patent Application Publication
(10) Pub. No.: US 2022/0274209 A1
(43) Pub. Date: Sep. 1, 2022

(54) LASER DRILLING APPARATUS

(71) Applicant: LASER MOTION TECH., LTD., Daejeon (KR)

(72) Inventor: Wan Hae CHOI, Daegu (KR)

(21) Appl. No.: 17/625,699

(22) PCT Filed: Jul. 10, 2020
(86) PCT No.: PCT/KR2020/009083

§ 371 Date: Jan. 7, 2022

(30) Foreign Application Priority Data
Jul. 17, 2019 (KR) 10-2019-0086637

(51) Int. Cl. B23K 26/382; B23K 26/06

(52) U.S. Cl. CPC B23K 26/382; B23K 26/0648

(57) ABSTRACT

This application relates to a laser drilling device. The device may include a variable focus module configured to vary a focal length of a laser beam. The device may also include an optical axis moving unit configured to, when an optical axis at a time point at which the laser beam passes through the variable focus module is incident is referred to as a reference optical axis, emit the laser beam by being moved by a predetermined distance with respect to the reference optical axis. The device may further include a first driving unit configured to rotate the optical axis moving unit, and a first focusing lens configured to focus the laser beam passing through the optical axis moving unit. A surface of a workpiece is drilled while rotating the optical axis moving unit by the first driving unit and gradually changing the focal length of the laser beam.

### TECHNICAL FIELD

The present disclosure relates to a laser drilling device, and more particularly, to a laser drilling device capable of rapidly performing hole processing by moving an optical axis of an incident laser beam to change a position of a surface of a workpiece, on which the laser beam is irradiated, and rotating an optical axis moving unit.

### BACKGROUND ART

FIG. 1 illustrates an example of a conventional laser drilling device. The conventional laser drilling device includes a focus variable module 1 configured to vary a focus of a laser beam, a first scanner module 2 and a second scanner module 3 that are configured to vary an irradiation position of the laser beam, and a focus lens module 4 configured to focus a laser beam. The laser beam passing through all the devices is irradiated onto a predetermined irradiation surface 5 of a workpiece.

The conventional laser drilling device has a limitation in implementing high-speed drilling because the first and second scanner modules 2 and 3 should be simultaneously driven in order to change a direction of the laser beam. In addition, when an area of the workpiece to be irradiated with a laser beam is large, it is necessary to irradiate the laser beam while moving the workpiece disposed below the focus lens module 4 using a separate stage, and thus costs required for the stage for moving the workpiece increases and installation is complicated. In addition, the problem of controlling a time delay required to move the stage should be solved.

### DISCLOSURE

### Technical Problem

The present invention is directed to providing a laser drilling device capable of rapidly performing hole processing by moving an optical axis of an incident laser beam to change a position of a surface of a workpiece, on which the laser beam is irradiated, and rotating an optical axis moving unit.

### Solution to Problem

One aspect of the present disclosure provides a laser drilling device including a variable focus module configured to vary a focal length of a laser beam, an optical axis moving unit configured to, when an optical axis at a time point at which the laser beam passes through the variable focus module is incident is referred to as a reference optical axis, emit the laser beam by being moved by a predetermined distance with respect to the reference optical axis, a first driving unit configured to rotate the optical axis moving unit, and a first focusing lens configured to focus the laser beam passing through the optical axis moving unit, wherein a surface of a workpiece is drilled while rotating the optical axis moving unit by the first driving unit and gradually changing the focal length of the laser beam to be increased by the variable focus module.

Further, the optical axis moving unit may include a first prism configured to refract the incident laser beam and a second prism disposed upside down with respect to the first prism to be spaced apart from the first prism.

Further, a size of a hole formed in the workpiece may increase as a distance by which the laser beam deviates from the reference optical axis increases.

Further, a scanner configured to change a direction of the laser beam irradiated on the surface of the workpiece may be provided between the optical axis moving unit and the first focusing lens.

Further, the first focusing lens may be a telecentric lens that allows a laser beam to be irradiated perpendicularly on the workpiece regardless of a position of the incident laser beam.

Further, the first focusing lens may be a telecentric lens that allows a laser beam to be irradiated perpendicularly on the workpiece regardless of a position of the incident laser beam, a second focusing lens may be disposed between the telecentric lens and the workpiece, and the laser drilling device may include a second driving unit configured to move the second focusing lens so that the second focusing lens moves in association with a direction in which the scanner irradiates the laser beam.

Further, a position of the optical axis of the laser beam may be changed by changing a distance between the first prism and the second prism.

### Advantageous Effects of Disclosure

A laser drilling device according to an embodiment of the present disclosure can rapidly perform hole processing by moving an optical axis of an incident laser beam to change a position of a surface of a workpiece, on which the laser beam is irradiated, and rotating an optical axis moving unit. In particular, according to an embodiment of the present disclosure, a tapered hole can be quickly processed.

Further, a direction in which a laser beam is irradiated can be changed quickly and easily by changing an optical axis of the laser beam by an optical axis moving unit, and rotating the optical axis moving unit by a first driving unit.

Further, according to an embodiment of the present disclosure, a region on which a laser beam is irradiated can be secured to be large by using a telecentric lens so that a large processing area can be secured in the workpiece.

Further, a second focusing lens, which is disposed at a rear end of a telecentric lens, provides an effect of easily processing a tapered hole with a large inclination by making a focal length of a laser beam shorter than that in a case of using only the telecentric lens to secure an angle of the laser beam incident on a surface of a workpiece.

### BRIEF DESCRIPTION OF DRAWINGS

FIG. 1 is a conceptual diagram of a conventional laser drilling device.

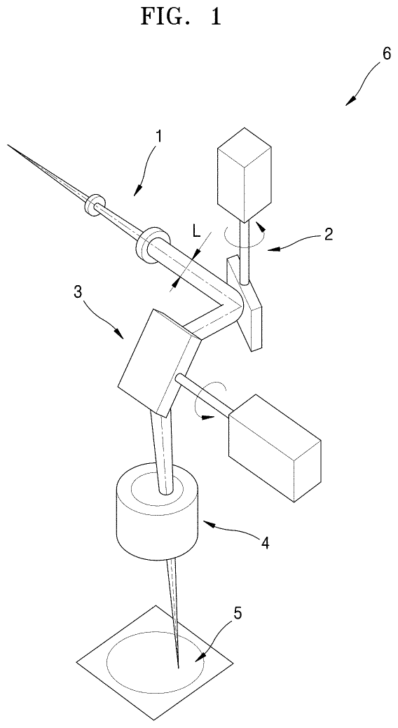

FIG. 2 is a conceptual diagram of a laser drilling device according to an embodiment of the present disclosure.

FIG. 3 is a diagram illustrating a state in which an optical axis moving unit shown in FIG. 2 is rotated by 180°.

FIG. 4 is a plan view illustrating a state in which a drilling operation is performed from a state of FIG. 2 to a state of FIG. 3.

FIG. 5 is a side view of a state in which the optical axis moving unit shown in FIG. 2 is rotated and drilling is performed.

FIG. 6 illustrates a state in which a focal length of a laser beam shown in FIG. 2 is changed to f2.

FIG. 7 is a side view of a state in which the optical axis moving unit shown in FIG. 2 is rotated and drilling is performed.

FIG. 8 illustrates a state in which the focal length of the laser beam shown in FIG. 2 is changed to f3.

FIG. 9 is a side view of a state in which the optical axis moving unit shown in FIG. 2 is rotated and drilling is performed.

FIG. 10 is a conceptual diagram of a laser drilling device according to another embodiment of the present disclosure.

FIG. 11 is a perspective view of a scanner employed in another embodiment of the present disclosure.

FIG. 12 is a conceptual diagram of a laser drilling device according to another embodiment of the present disclosure.

FIG. 13 is a block diagram of main components employed in FIG. 12.

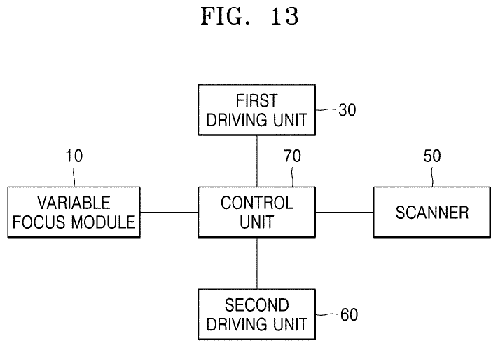

### MODE OF DISCLOSURE

Hereinafter, exemplary embodiments of the present disclosure will be described in detail with reference to the accompanying drawings.

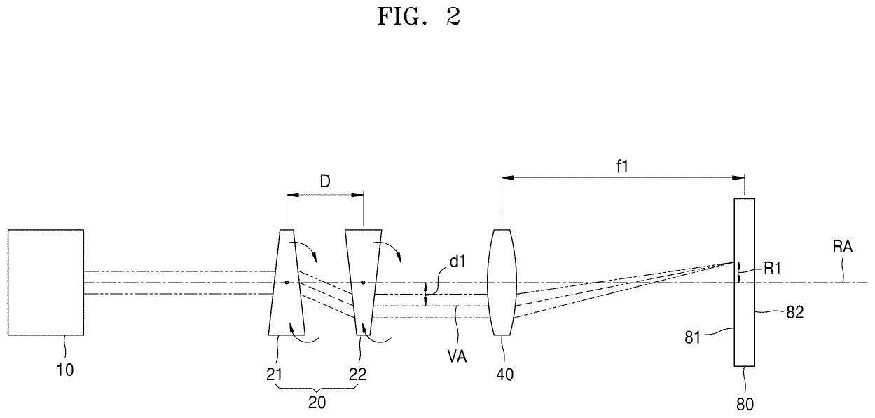

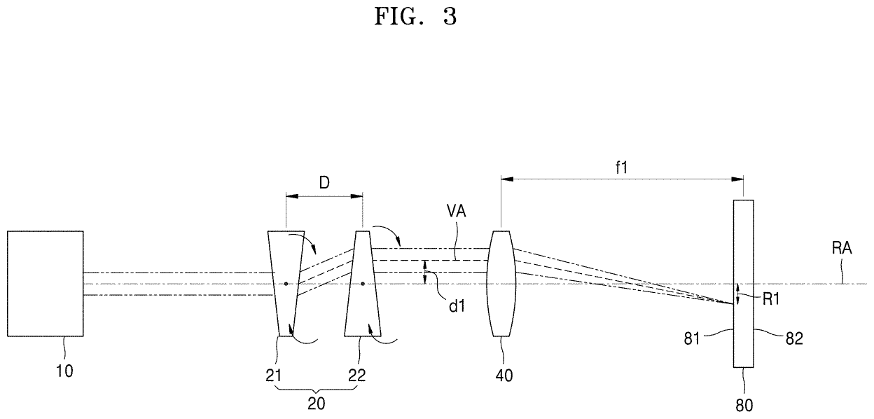

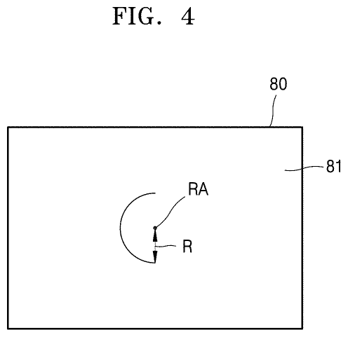

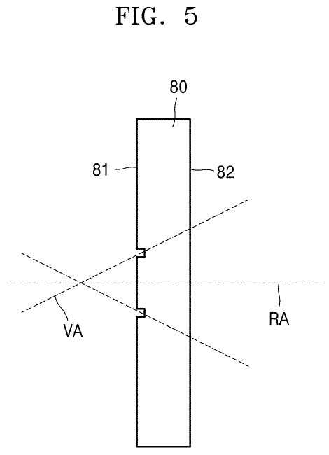

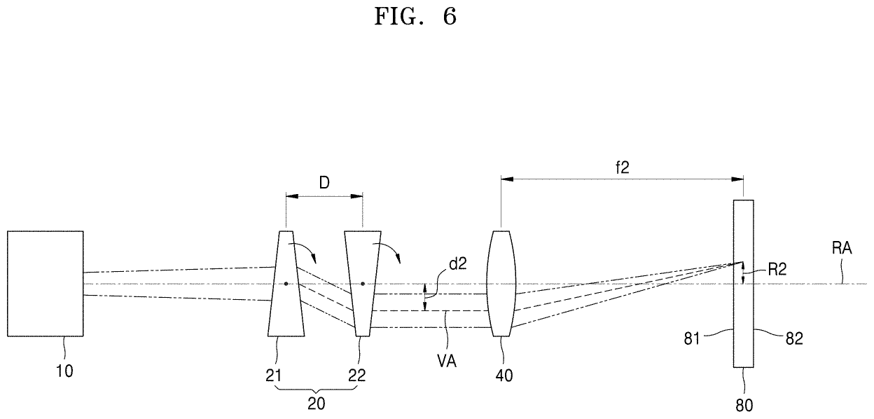

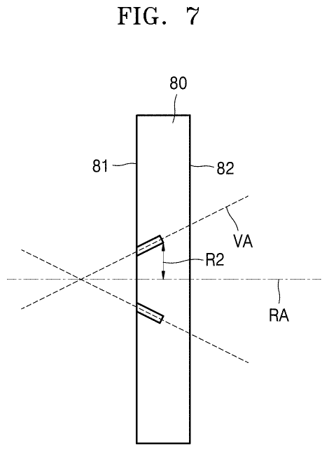

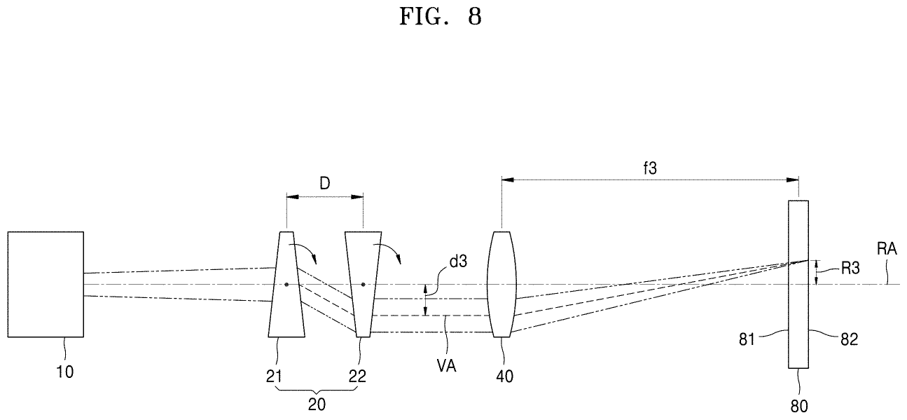

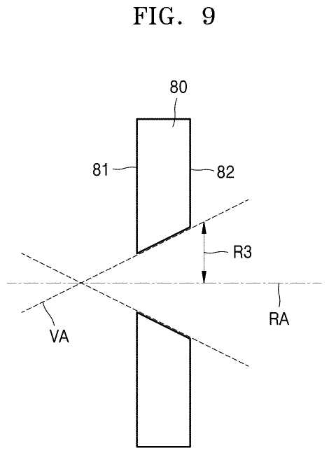

FIG. 2 is a conceptual diagram of a laser drilling device according to an embodiment of the present disclosure. FIG. 3 is a diagram illustrating a state in which an optical axis moving unit shown in FIG. 2 is rotated by 180°, FIG. 4 is a plan view illustrating a state in which a drilling operation is performed from a state of FIG. 2 to a state of FIG. 3, and FIG. 5 is a side view of a state in which the optical axis moving unit shown in FIG. 2 is rotated and drilling is performed. FIG. 6 illustrates a state in which a focal length of a laser beam shown in FIG. 2 is changed to f2, and FIG. 7 is a side view of a state in which the optical axis moving unit shown in FIG. 2 is rotated and drilling is performed. FIG. 8 illustrates a state in which the focal length of the laser beam shown in FIG. 2 is changed to f3, and FIG. 9 is a side view of a state in which the optical axis moving unit shown in FIG. 2 is rotated and drilling is performed.

The laser drilling device according to an embodiment of the present disclosure includes a variable focus module 10, an optical axis moving unit 20, a first driving unit 30, and a first focusing lens 40.

The variable focus module 10 is provided to vary a focal length of a laser beam. The variable focus module 10 includes a plurality of lenses having a variable distance therebetween. By adjusting the distance between the lenses, the focal length of the laser beam passing through the variable focus module 10 may be varied.

For example, the variable focus module 10 may include a concave lens and a convex lens, which are disposed side by side in an optical path direction of the laser beam, and a moving module (not shown) configured to move a position of the concave lens or the convex lens. Accordingly, as the distance between the concave lens and the convex lens is adjusted, the focal length of the laser beam passing through the variable focus module 10 may be adjusted. The laser beam passing through the variable focus module 10 may travel in a parallel state or a focused state, or may be diverged.

When an optical axis at a time point at which a laser beam passes through the variable focus module 10 is incident is referred to as a reference optical axis RA, the optical axis moving unit 20 is provided to emit the laser beam by being moved by a predetermined distance with respect to the reference optical axis RA. The laser beam is refracted while passing through the optical axis moving unit 20 so that a traveling path of the laser beam is changed.

Specifically, according to the present embodiment, the optical axis moving unit 20 includes a first prism 21 and a second prism 22.

As shown in FIG. 2, the first prism 21 refracts an incident laser beam. When a description is made based on FIG. 2, the laser beam is refracted downward by as much as a predetermined angle while passing through the first prism 21. The second prism 22 is disposed to be spaced apart from the first prism 21, and is disposed upside down with respect to the first prism 21. That is, the second prism 22 is disposed in a line-symmetrical structure with respect to the first prism 21.

The laser beam passing through the first prism 21 is secondarily refracted by the second prism 22. As shown in FIG. 2, an optical axis of the laser beam passing through the second prism 22 is moved in a state of being spaced apart from the reference optical axis RA by as much as a predetermined distance d1 so that the traveling path of the laser beam is changed.

FIG. 2 illustrates a case in which the laser beam passing through the variable focus module 10 travels horizontally, and the optical axis of the laser beam passing through the optical axis moving unit 20 is moved to be parallel with the reference optical axis RA by as much as the predetermined distance d1. A width of a double-dotted line in FIG. 2 schematically illustrates a size of the laser beam, and the optical axis of the laser beam refracted while passing through the optical axis moving unit 20 is indicated by a dotted line. Meanwhile, according to the present embodiment, each of the first and second prisms 21 and 22 is illustrated as having a trapezoidal cross section, but each of the first and second prisms 21 and 22 may have a triangular cross section.

When a distance between the first prism 21 and the second prism 22 is changed, a position of the optical axis of the laser beam is changed. Referring to FIG. 2, when a distance D between the first and second prisms increases, the distance d1 between an optical axis VA of the laser beam passing through the optical axis moving unit 20 and the reference optical axis RA increases, and thus the position of the optical axis passing through the first focusing lens 40 is changed.

The first driving unit 30 is provided to rotate the optical axis moving unit 20. According to the present embodiment, the first driving unit 30 rotates the optical axis moving unit 20 with the reference optical axis RA as a central axis. FIG. 3 illustrates a state in which the first driving unit 30 rotates the optical axis moving unit 20 by 180°.

As shown in FIG. 3, when the optical axis moving unit 20 is rotated by 180° by the first driving unit 30, the optical axis VA of the laser beam passing through the second prism 22 is rotated half a turn about the reference optical axis RA and is positioned opposite to the position (the state of FIG. 2) before the optical axis moving unit 20 is rotated by 180°. That is, the optical axis VA of the laser beam is rotated by 180° about the reference optical axis RA. FIG. 4 illustrates a state in which the optical axis VA of the laser beam is rotated by 180° and drilling is performed by a semicircle.

When the first driving unit 30 continuously rotates the optical axis moving unit 20, the optical axis VA of the laser beam is rotated about the reference optical axis RA, and the laser beam drills a surface of a workpiece 80 while drawing a circle on the surface of the workpiece 80.

When the distance between the first prism 21 and the second prism 22 is adjusted, the distance d1 by which the optical axis VA of the laser beam deviates from the reference optical axis RA may be adjusted. For example, when the distance between the first prism 21 and the second prism 22 increases, the optical axis VA of the laser beam moves further away from the reference optical axis RA.

Accordingly, as the distance by which the laser beam deviates from the reference optical axis RA increases, a hole formed in the workpiece 80 may be processed to a large size. That is, when the optical axis of the laser beam is moved away from the reference optical axis RA and then the optical axis moving unit 20 is rotated by the first driving unit 30, a hole whose radius is a distance from the reference optical axis RA to the optical axis of the laser beam may be processed on the surface of the workpiece 80.

The first focusing lens 40 is provided to focus the laser beam passing through the optical axis moving unit 20. The first focusing lens 40 forms a focus on the surface of the workpiece 80 by refracting and focusing the laser beam passing through the optical axis moving unit 20. The first focusing lens 40 may adopt a known configuration.

With such a configuration, the laser drilling device according to an embodiment of the present disclosure drills the surface of the workpiece 80 while rotating the optical axis moving unit 20 by the first driving unit 30 and gradually changing the focal length of the laser beam to be increased by the variable focus module 10

A detailed description will be made with reference to the drawings.

FIGS. 2, 3, and 5 illustrate a state in which a hole having a radius of R1 with respect to the reference optical axis RA is drilled on the surface of the workpiece 80. In FIGS. 2, 3, and 5, the focal length of the laser beam is f1, and a focus is formed on a surface 81 (front surface) of the workpiece 80. As the optical axis moving unit 20 rotates, the laser beam is rotated to form a groove in the workpiece 80, and the groove has a radius of R1 and a size when the laser beam is substantially focused.

FIGS. 6 and 7 illustrate a state in which the focal length of the laser beam is greatly changed. In FIGS. 6 and 7, the focal length of the laser beam is f2 (f2>f1), and a focus is formed inside the workpiece 80. FIGS. 6 and 7 illustrate a state in which a groove is formed in the workpiece 80 while the laser beam is rotated when the focal length of the laser beam is increased as compared with FIG. 3 and the optical axis moving unit 20 rotates. As the groove is continuously formed, the workpiece 80 is drilled.

The focus of the laser beam in FIG. 6 is adjusted to be formed on the optical axis of the laser beam in FIG. 3. Since a groove formed in FIG. 7 is placed on an extension line of the groove formed in FIG. 5 and the focal length is increased, a radius R2 in FIG. 7 is greater than the radius R1 in FIG. 5.

FIGS. 8 and 9 illustrate a state in which the focal length of the laser beam is changed to be greater than FIG. 6 and drilling is performed. In FIG. 8, the focal length of the laser beam is adjusted to be formed on the optical axis of the laser beam in FIG. 3 similar to FIG. 6.

Specifically, in FIG. 8, the focus of the laser beam is increased on the optical axis of the laser beam in FIG. 6 and is formed on a bottom surface of the workpiece 80. That is, the focal length of the laser beam is given as f3 (f3>f2). Since a groove formed in FIG. 9 is placed on an extension line of the groove formed in FIG. 7 and the focal length is increased, a radius R3 in FIG. 9 is greater than the radius R2 in FIG. 7.

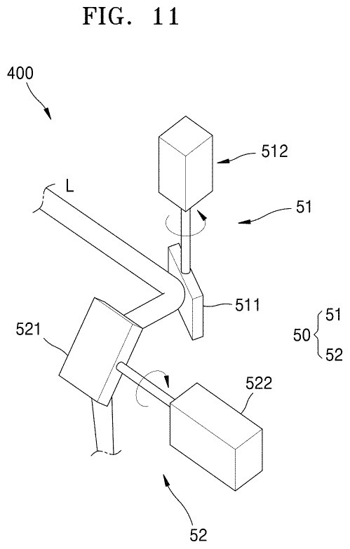

As a result, a tapered hole is processed in the workpiece 80 through the processes of FIGS. 2, 6, and 8. At this point, although each of the processes of FIGS. 2, 6, and 8 is discontinuously described for convenience of description, in practice, drilling of the hole is performed while the focus of the laser beam is continuously moved back and forth. As described above, according to an embodiment of the present disclosure, the focus of the laser beam is formed while being moved back on the optical axis of the laser beam that is initially irradiated on the surface of the workpiece 80, thereby enabling tapered hole processing as a result. In addition, drilling may be performed by arranging a scanner 50 of FIG. 11 on a front end of the first focusing lens 40 and irradiating a laser beam on a desired position of the workpiece 80.

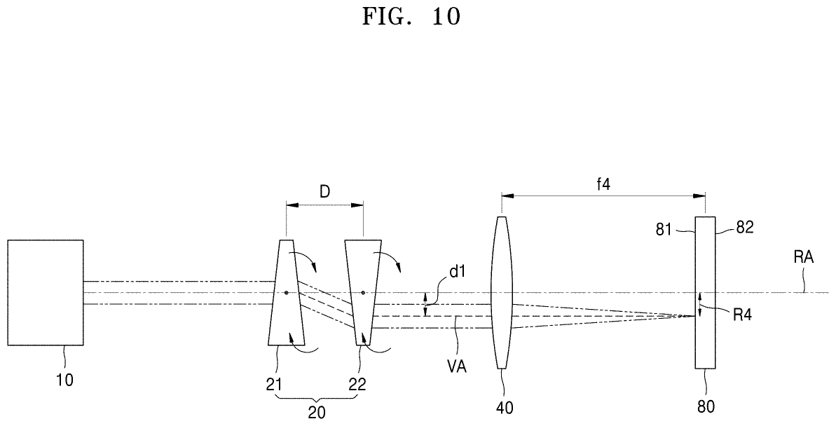

FIG. 10 illustrates another embodiment of the present disclosure. Like the embodiment of FIG. 2, the present embodiment includes a variable focus module 10, an optical axis moving unit 20, a first driving unit 30, and a first focusing lens 40. Since configurations of the variable focus module 10, the optical axis moving unit 20, and the first driving unit 30 are the same as those of the above-described embodiment, a detailed description thereof will be omitted.

However, in the present embodiment, a telecentric lens is used as the first focusing lens 40. The telecentric lens allows a laser beam to be irradiated perpendicularly on a workpiece 80 regardless of a position of the incident laser beam.

As shown in FIG. 10, when a laser beam passing through the optical axis moving unit 20 is incident on the telecentric lens, the laser beam passing through the telecentric lens is irradiated perpendicularly on the workpiece 80 regardless of an incidence angle of the laser beam. Since the telecentric lens itself has a known configuration, a detailed description thereof will be omitted.

In the present embodiment, by using the telecentric lens as the first focusing lens 40, a diameter of a hole formed in the workpiece 80 may be increased, and a hole having the same diameter at a front surface 81 and a rear surface 82 of the workpiece 80 may be easily processed.

According to another embodiment of the present disclosure, a variable focus module 10, an optical axis moving unit 20, a first driving unit 30, and a first focusing lens 40 may be included as in the embodiment of FIG. 2, and a scanner 50 configured to change a direction of a laser beam irradiated on a surface of a workpiece 80 may be provided between the optical axis moving unit 20 and the first focusing lens 40. In the present embodiment, since configurations of the variable focus module 10, the optical axis moving unit 20, the first driving unit 30, and the first focusing lens 40 are the same as those of the above-described embodiment, a detailed description thereof will be omitted.

The scanner 50 operates so that a laser beam is continuously or intermittently irradiated along a predetermined path onto a desired position over a predetermined entire surface of the workpiece 80.

As shown in FIG. 11, the scanner 50 may include a first mirror module 51 and a second mirror module 52. The first and second mirror modules 51 and 52 may be a so-called an X/Y scanner.

FIG. 11 illustrates the first and second mirror modules 51 and 52 according to the present embodiment. The first mirror module 51 may include a first mirror 511 configured to reflect a laser beam and a first motor 512 configured to rotate the first mirror 511. In addition, similar to the first mirror module 51, the second mirror module 52 may include a second mirror 521 configured to reflect a laser beam and a second motor 522 configured to rotate the second mirror 521.

As described above, the rotation of each of the first mirror 511 and the second mirror 521 constituting the scanner 50 may be combined so that the laser beam may be irradiated onto a desired position. Since the operation of the scanner by the mirror and the motor may be based on the related art, a detailed description thereof will be omitted.

The scanner 50 may be applied to the embodiment of FIG. 10. By using the scanner 50, a laser beam may be moved to an edge of the telecentric lens, and in this case, the entire lens surface of the telecentric lens may be used, so that an effect of securing a wide processing area in the workpiece 80 may be provided.

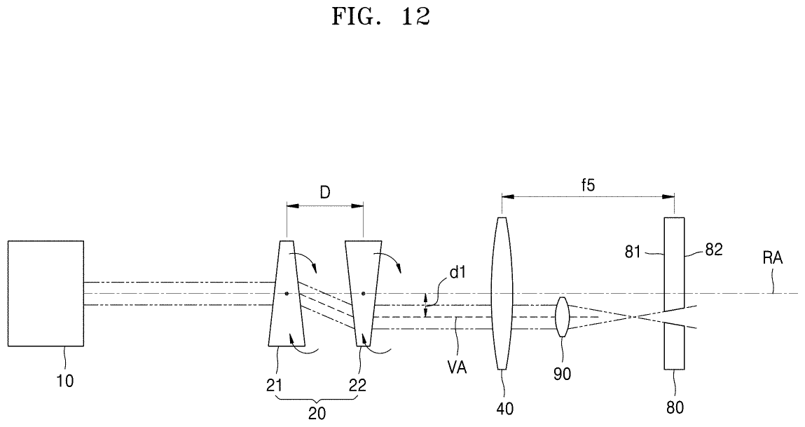

FIG. 12 illustrates another embodiment of the present disclosure. The present embodiment may be implemented by changing the embodiment in which the scanner 50 is applied to FIG. 10. Specifically, the present embodiment includes a variable focus module 10, an optical axis moving unit 20, a first driving unit 30, a telecentric lens, and a scanner 50, and further includes a second focusing lens 90 and a second driving unit 60. Since configurations of the variable focus module 10, the optical axis moving unit 20, the first driving unit 30, the telecentric lens, and the scanner 50 are the same as those of the above-described embodiment, a detailed description thereof will be omitted.

As shown in FIG. 12, the second focusing lens 90 is provided between the telecentric lens and the workpiece 80. The second focusing lens 90 reduces a focal length of a laser beam passing through the telecentric lens. Referring to FIG. 10, the focal length of the laser beam passing through the telecentric lens is f4, but, as the second focusing lens 90 is disposed, the focal length of the laser beam is reduced to f5. That is, a relationship of f4>f5 is established.

Accordingly, by reducing the focal length of the laser beam as compared with the case of using only the telecentric lens to secure a larger angle of the laser beam incident on the surface of the workpiece 80, it is possible to provide an effect that a tapered hole having a greater inclination (a greater virtual apex angle formed by extending and meeting outer walls of the hall is secured) may be easily processed. In addition, an effect is provided in which equipment may be reduced in size and compactly configured.

The second driving unit 60 is provided to move the second focusing lens 90 so that the second focusing lens 90 moves in association with a direction in which the scanner 50 irradiates the laser beam. That is, the second driving unit 60 moves the second focusing lens 90 along a direction in which the laser beam is irradiated by the scanner 50. Since the second driving unit 60 moves the second focusing lens 90 in accordance with the direction of the laser beam irradiated by the scanner 50, an effect of quickly processing a hole is provided by simply irradiating the laser beam to a desired position without the need to move the workpiece 80 using a separate stage.

According to the present embodiment, as the second focusing lens 90 moves, holes may be processed at a plurality of positions of the workpiece 80. Referring to FIG. 12, the optical axis moving unit 20 rotates the optical axis of the laser beam, and the scanner 50 allows the laser beam to pass through a position of the second focusing lens 90 shown in FIG. 12. Then, as the optical axis VA of the laser beam passing through the second focusing lens 90 rotates, a hole is processed in the workpiece 80. In this case, by gradually increasing the focal length of the laser beam passing through the second focusing lens 90 by the variable focus module 10, a tapered hole is processed by processes similar to those of FIGS. 2, 6, and 8.

When the scanner 50 attempts to process a hole by irradiating a laser beam onto another position of the workpiece 80, the second driving unit 60 moves the second focusing lens 90 to a position corresponding to the position set to be irradiated with the laser beam by the scanner 50. Subsequent hole processing is the same as described above, and holes may be quickly processed in a plurality of positions through the above process.

In the embodiment of FIG. 12, a control unit 70 controls such that the focal length of the laser beam is controlled by the variable focus module 10, and controls an operation of the scanner 50 to irradiate the laser beam onto a predetermined position. In addition, the control unit 70 controls the operation of the first driving unit 30 configured to rotate the optical axis moving unit 20 and an operation of the second driving unit 60 configured to move the second focusing lens 90. Implementation of the control unit 70 to control the operations of the variable focus module 10, the scanner 50, and the first and second driving units is based on the typical technique in a control field, and thus a detailed description thereof will be omitted.

As such, the laser drilling device according to an embodiment of the present disclosure provides an action or effect of rapidly processing a hole by moving an optical axis of an incident laser beam to change a position of a surface of the workpiece 80 on which the laser beam is irradiated and rotating the optical axis moving unit 20 to rotate the optical axis of the laser beam.

While the present disclosure has been described in detail with reference to the exemplary embodiments, the present disclosure is not limited to the above embodiments, and various modifications may be made without departing from the scope of the present disclosure. Accordingly, the genuine technical range of the present disclosure to be protected should be determined by the technical idea of the accompanying claims.

1. A laser drilling device comprising:
a variable focus module configured to vary a focal length of a laser beam;
an optical axis moving unit configured to, when an optical axis at a time point, at which the laser beam passes through the variable focus module is incident, is referred to as a reference optical axis, emit the laser beam by being moved by a predetermined distance with respect to the reference optical axis;
a first driving unit configured to rotate the optical axis moving unit; and
a first focusing lens configured to focus the laser beam passing through the optical axis moving unit,
wherein the laser drilling device is configured to drill a surface of a workpiece while rotating the optical axis moving unit by the first driving unit and gradually changing the focal length of the laser beam to be increased by the variable focus module.

2. The laser drilling device of claim 1, wherein the optical axis moving unit includes a first prism configured to refract the incident laser beam and a second prism disposed upside down with respect to the first prism to be spaced apart from the first prism.

3. The laser drilling device of claim 1, wherein a size of a hole formed in the workpiece increases as a distance by which the laser beam deviates from the reference optical axis increases.

4. The laser drilling device of claim 1, wherein a scanner configured to change a direction of the laser beam irradiated on the surface of the workpiece is provided between the optical axis moving unit and the first focusing lens.

5. The laser drilling device of claim 1, wherein the first focusing lens comprises a telecentric lens configured to allow a laser beam to be irradiated perpendicularly on the workpiece regardless of a position of the incident laser beam.

6. The laser drilling device of claim 4, wherein:
the first focusing lens comprises a telecentric lens configured to allow a laser beam to be irradiated perpendicularly on the workpiece regardless of a position of the incident laser beam,
a second focusing lens is disposed between the telecentric lens and the workpiece, and
the laser drilling device includes a second driving unit configured to move the second focusing lens so that the second focusing lens moves in association with a direction in which the scanner irradiates the laser beam.

7. The laser drilling device of claim 2, wherein a position of the optical axis of the laser beam is configured to be changed by changing a distance between the first prism and the second prism.
